(19) United States
(12) Patent Application Publication
(10) Pub. No.: US 2026/0012747 A1
(43) Pub. Date: Jan. 8, 2026

(54) AUDIO DEVICE AND METHOD FOR CONTROLLING SAME

(71) Applicant: SAMSUNG ELECTRONICSCO.,LTD., Suwon-si (KR)

(72) Inventors: Hanki KIM, Suwon-si (KR); Haekwang Park, Suwon-si (KR); Sunmin Kim, Suwon-si (KR); Yoonjae Lee, Wuwon-si (KR)

(73) Assignee: SAMSUNG ELECTRONICSCO., LTD., Suwon-si (KR)

(21) Appl. No.: 19/326,297

(22) Filed: Sep. 11, 2025

Related U.S. Application Data
(63) Continuation of application No. PCT/KR2024/001011, filed on Jan. 22, 2024.

(30) Foreign Application Priority Data
Mar. 17, 2023 (KR) 10-2023-0035383

(51) Int. Cl. H04S 7/00; G06F 3/16; H04R 5/02; H04S 3/00

(52) U.S. Cl. CPC H04S 7/308; G06F 3/165; H04R 5/02; H04S 3/008; H04S 2400/01

(57) ABSTRACT

An audio device includes communication circuitry configured to receive an audio signal from an external source and communicate with at least one external sub-speaker; a display configured to display unique identification information of the at least one external sub-speaker; an input interface configured to receive a user input indicating a position of the at least one external sub-speaker; memory storing at least one instruction; and at least one processor, wherein the at least one instruction, when executed by the at least one processor individually or collectively, causes the audio device to, based on a number of the at least one external sub-speaker and the position of the at least one external sub-speaker, control sound output from the at least one external sub-speaker.

### CROSS-REFERENCE TO RELATED APPLICATIONS

This application is a by-pass continuation application of International Application No. PCT/KR2024/001011, filed on Jan. 22, 2024, which is based on and claims priority to Korean Patent Application No. 10-2023-0035383, filed on Mar. 17, 2023, in the Korean Intellectual Property Office, the disclosures of which are incorporated by reference herein in their entireties.

### BACKGROUND

### 1. Field

The disclosure relates to an audio device and a method for controlling the audio device.

### 2. Description of Related Art

With recent developments in video and audio processing technologies, high-quality video and audio content are being produced in large quantities. Accordingly, display apparatuses include audio devices that output sound by themselves. Also, research is actively being conducted on stereophonic sound technology that allows users to experience spatial sound by simultaneously playing audio through a plurality of speakers by connecting with audio devices located outside the display apparatus.

### SUMMARY

Provided are an audio device and a method for controlling sound to allow an output audio signal to vary depending on a position of an external sub-speaker connected to the audio device.

According to an aspect of the disclosure, an audio device includes communication circuitry configured to receive an audio signal from an external source and communicate with at least one external sub-speaker; a display configured to display unique identification information of the at least one external sub-speaker; an input interface configured to receive a user input indicating a position of the at least one external sub-speaker; memory storing at least one instruction; and at least one processor, wherein the at least one instruction, when executed by the at least one processor individually or collectively, causes the audio device to, based on a number of the at least one external sub-speaker and the position of the at least one external sub-speaker, control sound output from the at least one external sub-speaker.

The position may include a first zone, a second zone, a third zone, a fourth zone, a firth zone, and a sixth zone obtained by dividing a space around a user into six zones.

The first zone, the second zone, the third zone, the fourth zone, the fifth zone, and the sixth zone may respectively include a front left, a front center, a front right, a rear left, a rear center, and a rear right, relative to the user.

The at least one instruction, when executed by the at least one processor individually or collectively, may cause the audio device to, based on the number of the at least one external sub-speaker and the position of the at least one external sub-speaker, control the sound output from the at least one external sub-speaker such that an emphasis effect applied to the sound output from the at least one external sub-speaker varies.

The emphasis effect may include at least one of a front effect, a stereo effect, or a surround effect.

The audio at least one instruction, when executed by the at least one processor individually or collectively, may cause the audio device to, based on a number of channels of the audio signal being two, extract a main signal and an ambient signal from the audio signal, and based on the emphasis effect, control the sound output from the at least one external sub-speaker such that the at least one external sub-speaker to outputs one of the main signal or the ambient signal.

The at least one instruction, when executed by the at least one processor individually or collectively, may cause the audio device to, based on a number of channels of the audio signal being five or more, extract a left surround signal and a right surround signal from the audio signal, and based on the emphasis effect, control the sound output from the at least one external sub-speaker such that the at least one external sub-speaker outputs at least one of the left surround signal or the right surround signal.

The number of the at least one external sub-speaker may be one, and the at least one instruction, when executed by the at least one processor individually or collectively, may cause the audio device to control the sound output from the at least one external sub-speaker such that a defined weight is applied to the right surround signal based on the position being rear left, and a defined weight is applied to the left surround signal based on the position being rear right.

The at least one instruction, when executed by the at least one processor individually or collectively, may cause the audio device to, based on a number of channels of the audio signal, determine a required value of network bandwidth for transmitting sound to be output from the audio device to the at least one external sub-speaker, and based on the required value of network bandwidth and a value of currently available network bandwidth received from the communication circuitry, determine a transmission method of the sound as either pulse code modulation (PCM) or bitstream.

The at least one instruction, when executed by the at least one processor individually or collectively, may cause the audio device to, based on the required value of network bandwidth being greater than the value of currently available network bandwidth, determine the transmission method of the sound as the bitstream.

The audio device may further include a main speaker provided inside the audio device, and the at least one instruction, when executed by the at least one processor individually or collectively, may cause the audio device to, based on the number and the position of the at least one external sub-speaker, control sound output from the main speaker.

According to an aspect of the disclosure, a method for controlling an audio device includes receiving an audio signal from an external source; communicating with at least one external sub-speaker; displaying unique identification information of the at least one external sub-speaker on a display; receiving a user input indicating a position of the at least one external sub-speaker; and controlling sound output from the at least one external sub-speaker based on a number of the at least one external sub-speaker and the position of the at least one external sub-speaker.

The receiving the user input indicating the position may include receiving an input indicating one of a front left, a front center, a front right, a rear left, a rear center, or a rear right, relative to a user.

The controlling the sound output from the at least one external sub-speaker may include, based on the number of the at least one external sub-speaker and the position of the at least one external sub-speaker, controlling the sound output from the at least one external sub-speaker such that an emphasis effect applied to the sound output from the at least one external sub-speaker varies.

The controlling the sound output from the at least one external sub-speaker may include extracting a main signal and an ambient signal from the audio signal based on a number of channels of the audio signal being two; and controlling the sound output from the at least one external sub-speaker such that the at least one external sub-speaker outputs one of the main signal or the ambient signal according to the emphasis effect.

According to an aspect of the disclosure, an audio device and a method for controlling the same may provide optimal sound to a user by receiving a user input indicating an approximate position of at least one external sub-speaker and processing an audio signal based on the position and number of the external sub-speakers.

Additionally, according to an aspect of the disclosure, the audio device and method for controlling the same may provide optimal sound to a user even with a low network bandwidth value by providing a method for determining a sound transmission method according to a value of available network bandwidth.

Furthermore, according to an aspect of the disclosure, the audio device and method for controlling the same may provide optimal sound to a user through a combination of sound output from a plurality of speakers by controlling both sound output from at least one external sub-speaker and sound output from a main speaker.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 illustrates an audio system, implemented by an audio device 1 and external sub-speakers 10, according to an embodiment.

FIG. 2 is a control block diagram of an audio device 1 according to an embodiment.

FIGS. 3A and 3B illustrate an example method of receiving a user input indicating a position of an external sub-speaker 10 through a guide displayed on a display 200 of an audio device 1 according to an embodiment.

FIGS. 4A and 4B illustrate an example method of receiving a user input indicating a position of an external sub-speaker 10 through an input interface 300 of an audio device 1 according to an embodiment.

FIGS. 5A and 5B illustrate an example method of receiving a user input indicating a position of an external sub-speaker 10 through an input interface 300 of an audio device 1 according to an embodiment.

FIG. 6 illustrates an example of dividing a space around a user into six zones to allow a controller 500 of an audio device 1 to determine a position of an external sub-speaker 10 according to an embodiment.

FIG. 7 is a flowchart illustrating a method for controlling an audio device 1 according to an embodiment.

FIGS. 8A and 8B illustrate a method of processing sound when the number of channels of an audio signal received by an audio device 1 is two, according to an embodiment.

FIGS. 9A and 9B illustrate a method of processing audio when the number of channels of an audio signal received by an audio device 1 is five, according to an embodiment.

FIG. 10 is a flowchart illustrating a method for controlling an audio device 1 according to an embodiment.

FIG. 11 is a flowchart illustrating a method for controlling an audio device 1 according to an embodiment.

### DETAILED DESCRIPTION

Various embodiments of the disclosure and terms used therein are not intended to limit the technical features described in the disclosure to specific embodiments, and should be understood to include various modifications, equivalents, or substitutes of the corresponding embodiments which do not depart from the scope and spirit of the disclosure.

In connection with the description of the drawings, similar reference numerals may be used for similar or related components.

The singular form of a noun corresponding to an item may include one or a plurality of the items unless clearly indicated otherwise in a related context.

In the disclosure, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, such terms as “1st” and “2nd,” or “first” and “second” may be used to simply distinguish a corresponding component from another, and does not limit the components in other aspect (for example, importance or order).

When one (e.g., a first) element is referred to as being “coupled” or “connected” to another (e.g., a second) element with or without the term “functionally” or “communicatively,” it means that the one element is connected to the other element directly, wirelessly, or via a third element.

It will be understood that the terms “include”, “comprise” and/or “have” when used in this specification, specify the presence of stated features, integers, steps, operations, elements, and/or components, but do not preclude the presence or addition of one or more other features, integers, steps, operations, elements, components, and/or groups thereof.

It is to be understood that if a certain component is referred to as being “coupled with,” “coupled to,” “supported on” or “in contact with” another component, it means that the component may be coupled with the other component directly or indirectly via a third component.

Throughout the specification, when a member is referred to as being “on” another member, the member is in contact with another member or yet another member is interposed between the two members.

The term “and/or” includes combinations of one or all of a plurality of associated listed items.

Hereinafter, the operating principles and embodiments of the disclosure will be described with reference to the accompanying drawings.

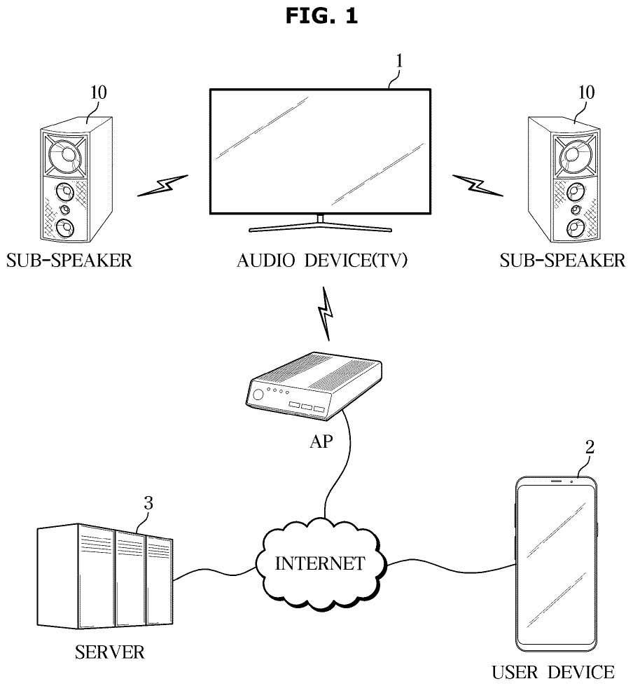

FIG. 1 illustrates an audio system implemented by an audio device 1 and external sub-speakers 10, according to an embodiment.

Referring to FIG. 1, the audio device may be included in a display apparatus that receives and plays video and audio signals from an external source.

In this specification, a television (TV) is provided as an example of the display apparatus, but the disclosure is not limited thereto, and any apparatus may be used as long as it includes an audio signal from an external source and includes a configuration capable of playing audio. For example, there may be a TV, a projector, a three-dimensional (3D) hologram generator, a virtual reality (VR) device, and the like.

The audio device may include a built-in speaker that outputs audio, and may be connected to at least one external sub-speaker 10 to play sound from outside. For example, although FIG. 1 illustrates an audio system having two external sub-speakers 10, the number of external sub-speaker 10 may be one or two.

The audio device 1 may include a communication module capable of communicating with a user device 2 or a server 3, a user interface that receives user input or outputs information to a user, at least one processor that controls operation of the audio device 1, and at least one memory storing a program for controlling operation of the audio device 1.

The server 3 may include a communication module capable of communicating with another server 3, the audio device 1, or the user device 2, at least one processor capable of processing data received from the other server 3, the audio device 1, or the user device 2, and at least one memory capable of storing a program for processing data or processed data. The server 3 may be implemented with various computing devices, such as a workstation, a cloud, a data drive, a data station, and the like.

The user device 2 may be carried by a user, or placed in a user's home or office, or the like. The user device 2 may include a personal computer, a terminal, a portable telephone, a smartphone, a handheld device, a wearable device, and the like, without being limited thereto.

The memory of the user device 2 may store a program for controlling audio device 1, for example, an application. The application may be sold installed on the user device 2, or may be downloaded from an external server 3 for installation.

By executing the application installed on the user device 2 by a user, the user may access the server 3, generate a user account, and perform communication with the server 3 based on the login user account to register the audio device 1.

A user may control the audio device 1 using the application installed on the user device 2. For example, by logging into a user account with the application installed on the user device 2, the audio device 1 registered in the user account appears, and by inputting a control command for the audio device 1, the control command may be delivered to the audio device 1 via the server.

A network may include both a wired network and a wireless network. The wired network may include a cable network or a telephone network, and the wireless network may include any networks transmitting and receiving a signal via radio waves. The wired network and the wireless network may be connected to each other.

The network may include a Wide Area Network (WAN) such as the Internet, a Local Area Network (LAN) formed around an Access Point (AP), and a short range wireless network not using an AP. The short range wireless network may include Bluetooth (IEEE 802.15.1, Zigbee (IEEE 802.15.4, Wi-Fi Direct, Near Field Communication (NFC), and Z-Wave, without being limited thereto.

The AP may connect the audio device 1 or the user device 2 to a WAN connected to the server 3. The audio device 1 or the user device 2 may be connected to the server 3 via a WAN.

The AP may communicate with the audio device 1 or the user device 2 using wireless communication such as Wi-Fi (IEEE 802.11), Bluetooth (IEEE 802.15.1), Zigbee (IEEE 802.15.4), and the like, and access a WAN using wired communication, without being limited thereto.

According to various embodiments, the audio device 1 may be directly connected to the user device 2 or server 3 without going through an AP.

The audio device 1 may be connected to the user device 2 or the server 3 via a long range wireless network or a short range wireless network.

For example, the audio device 1 may be connected to the user device 2 via a short range wireless network (e.g., Wi-Fi Direct).

In another example, the audio device 1 may be connected to the user device 2 or the server 3 via a WAN using a long range wireless network (e.g., a cellular communication module).

In still another example, the audio device 1 may access a WAN using wired communication, and may be connected to the user device 2 or the server 3 via a WAN.

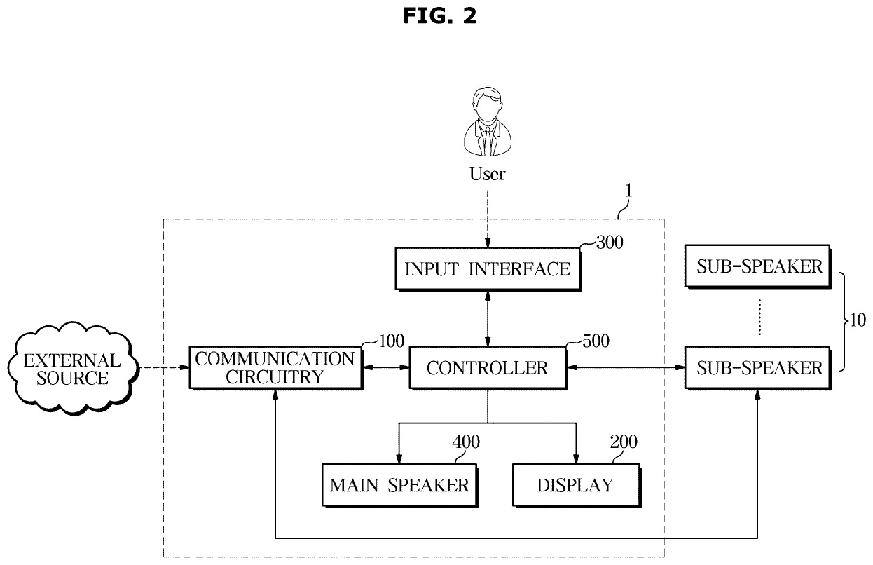

FIG. 2 is a control block diagram of the audio device 1, according to an embodiment.

Referring to FIG. 2, the audio device 1 may include communication circuitry 100, a display 200, an input interface 300, a main speaker 400 that outputs sound, and a controller 500 that controls the aforementioned components and sound output from the external sub-speaker 10.

The communication circuitry 100 may receive an audio signal from an external source and communicate with at least one external sub-speaker 10. The received audio signal may be output through the main speaker 400 and the external sub-speaker 10 through defined signal processing by the controller 500 to be described later.

The communication circuitry 100 may receive unique identification information from the external sub-speaker 10.

The display 200 may visually provide defined information to the outside of the audio device 1. For example, the display 200 may display unique identification information transmitted from the external sub-speaker 10. In the disclosure, a character string is illustrated as an example of unique identification information, but the disclosure is not limited thereto, and any information that may recognize different types of external sub-speakers 10 may be used as unique identification information.

For example, the unique identification information may be a character string formed according to a defined rule to distinguish a type, performance, product number, and the like of the external sub-speaker 10. Also, the unique identification information may also be a product name, a serial number, a nickname of a product designated in advance by a user, or the like.

Displaying the unique identification information on the display 200 may allow identification of the external sub-speaker 10 the user currently wants to control via the audio device 1.

Additionally, the display 200 may display a guide for receiving a user input indicating a position of the external sub-speaker 10. The user may conveniently input (enter) the position of the external sub-speaker 10 to the input interface 300 by viewing the guide displayed as an image on the display 200.

The display 200 may include a display panel. The display panel may be, for example, a Liquid Crystal Display (LCD), a Light Emitting Diode (LED), an Organic LED (OLED), and the like.

The input interface 300 may receive a user input indicating a position of the external sub-speaker 10. Receiving the user input indicating the position of the external sub-speaker 10 may include receiving the input according to a preset guide.

For example, the guide may be provided to allow the user to select by displaying an image on the display 200 as described above. However, the guide may be in any form that allows the user to input the position of the external sub-speaker 10.

For example, the guide may be provided as voice, and the position of the external sub-speaker 10 may be received as a user's voice through the input interface 300.

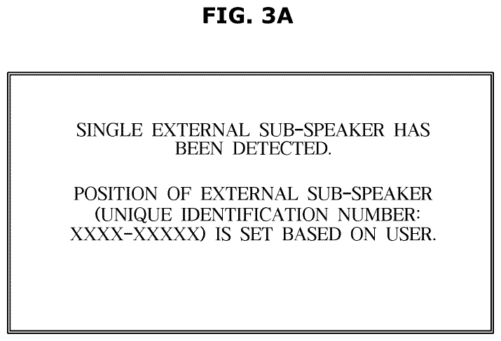

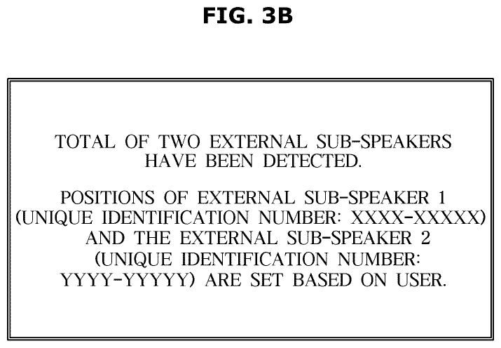

FIG. 3 illustrates an example method of receiving a user input indicating a position of the external sub-speaker 10 through a guide displayed on the display 200 of the audio device 1 according to an embodiment.

Referring to FIG. 3, the display 200 may display a guide including the number and unique identification information of external sub-speakers 10 currently connected to the audio device 1 through the communication circuitry 100.

FIG. 3A shows an example when the number of external sub-speakers 10 is one, and FIG. 3B shows an example when the number of external sub-speakers 10 is two. Through the unique identification information displayed in the image shown on the display 200, the user may identify which external sub-speaker 10 to select.

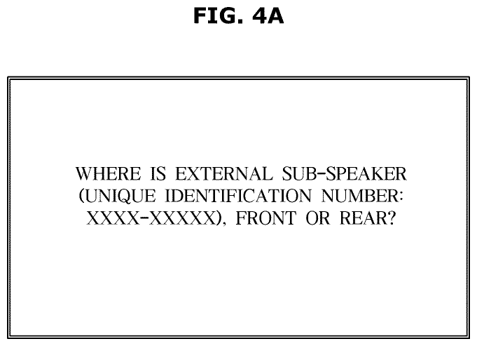

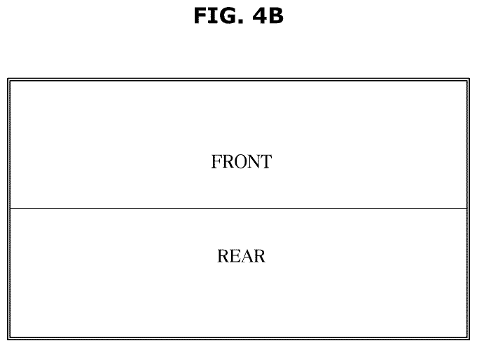

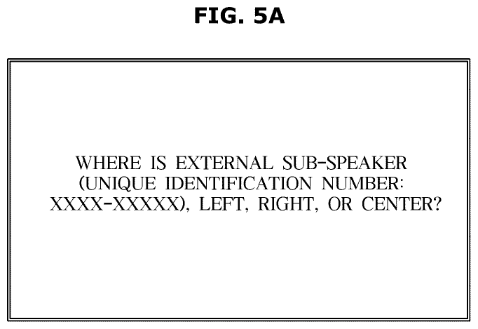

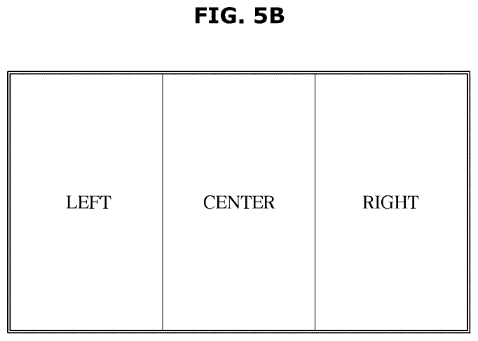

FIG. 4 and FIG. 5 illustrate an example method of receiving a user input indicating a position of the external sub-speaker 10 through the input interface 300 of the audio device 1, according to an embodiment.

Referring to FIG. 4 and FIG. 5, a user may go through two input steps through the input interface 300 according to a guide displayed on the display 200.

In one step, a user input indicating a position of the external sub-speaker 10 as either front or rear may be received from the user, as shown in FIG. 4.

The user may determine whether the external sub-speaker 10 is located in the front or rear according to a guide shown in FIG. 4A, and then may input either the front or rear according to a guide shown in FIG. 4B.

In another step, a user input indicating a position of the external sub-speaker 10 as either the left, center, or right side may be received from the user, as shown in FIG. 5.

The user may determine whether the external sub-speaker 10 is located on the left, center, or right side according to a guide shown in FIG. 5A, and then may input one of the left, center, or right according to a guide shown in FIG. 5B.

The main speaker 400 may be built into the audio device 1 to directly output sound. Sound output from the main speaker 400 and sound output from at least one external sub-speaker 10 may be different.

This is because the external sub-speaker is located in a different place from the main speaker 400. The external sub-speaker outputs sound toward the user in a different direction from the main speaker 400 at a different location from the main speaker 400, outputting sound different from that of the main speaker 400 and allowing the user to feel a sense of space.

Also, when receiving a user input indicating a position of the external sub-speaker 10, it may be assumed that a position of the audio device 1 including the main speaker 400 is located at the front center (second zone) of the user.

This takes into account a typical usage pattern of a display apparatus by a user. In order to view an image on the display apparatus, a user usually positions himself or herself so that he or she can face the display apparatus frontally.

Therefore, sound output from the main speaker 400 may be main signals extracted from among received audio signals.

The controller 500 is electrically connected to the aforementioned communication circuitry 100, display 200, input interface 300, and main speaker 400, and controls each of the components.

The controller 500 may include hardware such as a CPU or memory, and software such as a control program. For example, the controller 500 may include at least one memory that stores data in the form of program or algorithm for controlling operation of components in the audio device 1, and at least one processor that performs the aforementioned operations using the data stored in the at least one memory.

The memory and the processor may be implemented as separate chips. The processor may include one or more processor chips or one or more processing cores. The memory may include one or more memory chips or one or more memory blocks. Also, the memory and the processor may be implemented as a single chip.

The controller 500 may determine a position of the external sub-speaker 10 based on information input from a user through the input interface 300.

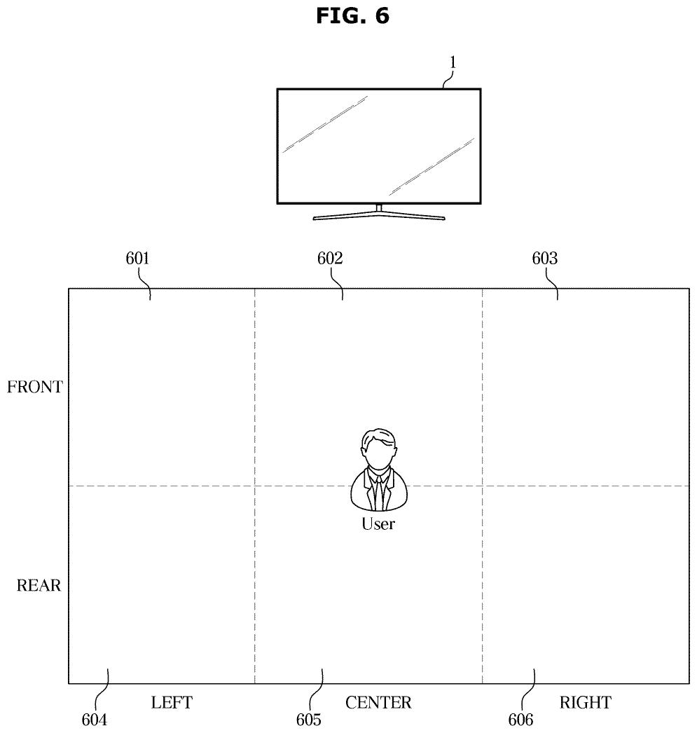

FIG. 6 illustrates an example of dividing a space around a user into six zones to allow the controller 500 of the audio device 1 to determine a position of the external sub-speaker 10 according to an embodiment.

Referring to FIG. 6, the position of the external sub-speaker 10 may include a first zone 601, a second zone 602, a third zone 603, a fourth zone 604, a fifth zone 605, and a sixth zone 606 obtained by dividing a space around the user into six zones based on the user.

The first to sixth zones may be classified as either front or rear and as one of left, right, or center based on the user.

The controller 500 may determine whether the position of the external sub-speaker 10 corresponds to either the front (first zone to third zone) or the rear (fourth zone to sixth zone) based on receiving an input of either front or rear from the input interface 300.

Additionally, the controller 500 may determine whether the position of the external sub-speaker 10 corresponds to one of left (first zone or fourth zone), center (second zone or fifth zone), or right (third zone or sixth zone) based on receiving an input of one of left, center, or right from the input interface 300.

For example, the position of the external sub-speaker 10 may be determined by dividing the space around the user into two parts vertically and three parts horizontally. Therefore, the position of the external sub-speaker 10 may be one of front left (first zone), front center (second zone), front right (third zone), rear left (fourth zone), rear center (fifth zone), or rear right (sixth zone).

By allowing selection of the approximate position of the external sub-speaker 10 through a guide centered on the user, more convenient sound control may be achieved.

In existing technologies, a method of determining the position of the external sub-speaker 10 using various sensors (microphones, cameras, and the like) was used. However, recognition errors occurred in various sensors depending on the position of the external sub-speaker 10.

Therefore, according to the disclosure, the position of the external sub-speaker 10 may be easily obtained by receiving a user input indicating one of six zones relative to the user, thereby efficiently and accurately determining the position of the external sub-speaker 10.

The controller 500 may control sound output from the external sub-speaker 10 by appropriately processing the received audio signal.

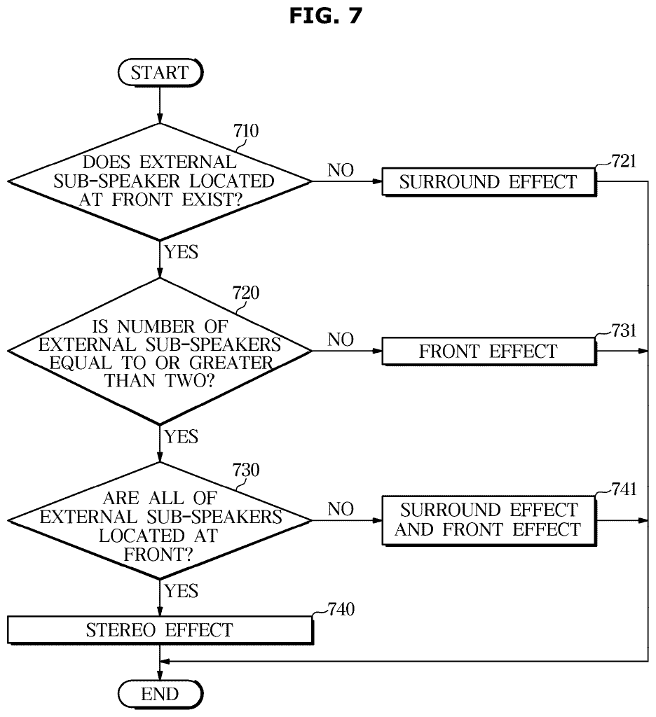

FIG. 7 is a flowchart illustrating a method for controlling the audio device 1 according to an embodiment.

The controller 500 may control an emphasis effect of output sound depending on the number and position of at least one external sub-speaker 10.

The emphasis effect may include at least one of a front effect, a stereo effect, or a surround effect.

The front effect outputs sound as if it were being played across a wider area in front of the user. The stereo effect outputs sound to enhance a sense of space by playing sound from both the left and right sides of the user. The surround effect outputs sound from behind the user to increase a sense of space and presence.

For example, because the main speaker 400 is located at the front center (second zone) of the user, the user may add at least one external sub-speaker 10 to output sound separately from sound output at the main speaker 400.

For example, in a case where an additional external sub-speaker 10 is placed in front of the user, appropriate sound is output according to the position of the external sub-speaker 10, allowing the user to feel that sound comes from a wider area in front of the user, which is the front effect.

Referring to FIG. 7, the controller 500 may determine whether an external sub-speaker 10 located at the front exists, which corresponds to a case where the user selects the front (first zone to third zone) as a position of at least one external sub-speaker 10. (710)

In a case where the external sub-speaker 10 located at the front does not exist, the controller 500 may determine that the external sub-speaker 10 is located at the rear (fourth zone to sixth zone). In this case, the controller 500 may determine an emphasis effect for sound output from the external sub-speaker 10 as a surround effect. (721)

In a case where the external sub-speaker 10 located at the front exists, the controller 500 may determine whether the number of external sub-speakers 10 is two or more. (720) In a case where a single external sub-speaker 10 is located at the front, the controller 500 may determine an emphasis effect for sound output from the external sub-speaker 10 as a front effect. (731)

In a case where two or more external sub-speakers 10 are located at the front, the controller 500 may determine whether all of the external sub-speakers 10 are located at the front. (730) In a case where all of the external sub-speakers 10 are located at the front, the controller 500 may determine an emphasis effect of sound output from the two or more external sub-speakers 10 as a stereo effect. (740)

In a case where not all of the external sub-speakers 10 are located at the front and at least one external sub-speaker 10 is located at the rear, the controller 500 may determine an emphasis effect of sound output from the two or more external sub-speakers 10 as a front effect and a surround effect. (741)

The controller 500 may control to process sound output from the external sub-speaker 10 according to the determined emphasis effect. In processing sound according to the emphasis effect, the controller 500 may process sound differently depending on the number of channels of an audio signal received from an external source.

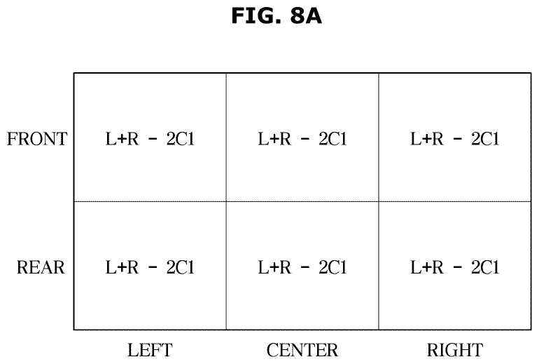

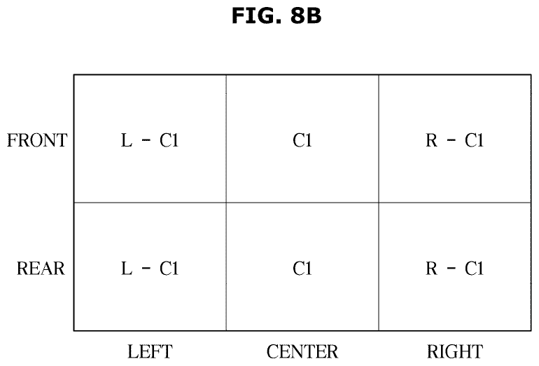

FIG. 8 illustrates a method of processing sound when the number of channels of an audio signal received by the audio device 1 is two, according to an embodiment.

In a case where the number of channels of the audio signal is two, the controller 500 may extract a main signal and an ambient signal from the audio signal received by the audio device 1. The two-channel audio signal may be recorded by being distinguished into a left signal L and a right signal R.

Therefore, when extracting the main signal and the ambient signal, the controller 500 may process the left signal L and the right signal R according to a defined method.

For example, a main signal C1 may be extracted using the left signal L and the right signal R, and ambient signals L-C1 and R-C1 may be extracted by canceling (subtracting) the main signal C1 from the left signal L or canceling the main signal C1 from the right signal R.

The main signal C1 may be a common signal that is equally included in the left signal L and the right signal R. Extracting the common signal may be performed by calculating a correlation coefficient, which represents a degree of similarity between the left signal L and the right signal R, as a value from 0 to 1.

Sound played by the external sub-speaker 10 may be processed differently depending on whether there is one or two external sub-speakers 10.

FIG. 8A illustrates an example method of processing sound in a case where there is one external sub-speaker 10, and FIG. 8B illustrates an example method of processing sound in a case where there are two external sub-speakers 10.

Referring to FIG. 8A, in a case where there is one external sub-speaker 10, the controller 500 may control sound to reproduce (output) both the ambient signal L-C1 extracted from the left signal L and the ambient signal R-C1 extracted from the right signal R, regardless of the position of the external sub-speaker 10.

Referring to FIG. 8B, in a case where there are two external sub-speakers 10, the controller 500 may control sound to reproduce the ambient signal L-C1 extracted from the left signal when the external sub-speaker 10 is located on the left, may control sound to reproduce the ambient signal R-C1 extracted from the right signal when the external sub-speaker 10 is located on the right, and may control sound to reproduce the main signal C1 when the external sub-speaker 10 is located in the center.

Therefore, in a case where there are two external sub-speakers 10, when the external sub-speaker 10 is located in either the first zone or the fourth zone, the controller may control sound to reproduce the ambient signal L-C1 extracted from the left signal, when the external sub-speaker 10 is located in either the third zone or the sixth zone, the controller may control sound to reproduce the ambient signal R-C1 extracted from the right signal, and when the external sub-speaker 10 is located in either the second zone or the fifth zone, the controller may control sound to reproduce the main signal CL.

In this case, the controller 500 may control sound so that the main speaker 400 reproduces the main signal C1.

By processing the two-channel audio signal as described above, the aforementioned sound emphasis effect may be realized according to the number and position of the external sub-speakers 10.

The following describes examples of realizing the aforementioned emphasis effect of sound based on the number and position of the external sub-speakers 10 by processing the two-channel audio signal according to connection scenarios based on the number and position of each external sub-speaker 10.

### <Connection Scenario 1>

Connection scenario 1 is a case where only one external sub-speaker 10 is located at the front. In this case, because the controller 500 determines the front effect as an emphasis effect as described above, the main speaker 400 may reproduce the main signal C1, and the external sub-speaker 10 may reproduce both the ambient signal L-C1 extracted from the left signal and the ambient signal R-C1 extracted from the right signal, thereby realizing the front effect.

### <Connection Scenario 2>

Connection scenario 2 is a case where two external sub-speakers 10 are located at the front left (first zone) and front right (third zone). In this case, because the controller 500 determines the stereo effect as an emphasis effect as described above. Therefore, when the external sub-speaker 10 is positioned on the left or right, ambient signal L-C1 or R-C1 may be reproduced, and the main speaker 400 may reproduce the main signal C1, thereby realizing the stereo effect.

### <Connection Scenario 3>

Connection scenario 3 is a case where there are two external sub-speakers 10 positioned diagonally based on the user. For example, one external sub-speaker 10 may be located at the front left (first zone) and the other may be located at the rear right (sixth zone), or one external sub-speaker 10 may be located at the front right (third zone) and the other may be located at the rear left (fourth zone).

In this case, because the controller 500 determines the front effect and the surround effect as an emphasis effect as described above, when the external sub-speaker 10 is positioned on the left or right, an ambient signal L-C1 or R-C1 may be reproduced, and the main speaker 400 may reproduce the main signal C1, thereby realizing the front effect and the surround effect.

### <Connection Scenario 4>

Connection scenario 4 is a case where only one external sub-speaker 10 is located at the rear. In this case, because the controller 500 determines the surround effect as an emphasis effect as described above, the main speaker 400 may reproduce the main signal C1, and the external sub-speaker 10 may reproduce both the ambient signal L-C1 extracted from the left signal and the ambient signal R-C1 extracted from the right signal, thereby realizing the surround effect.

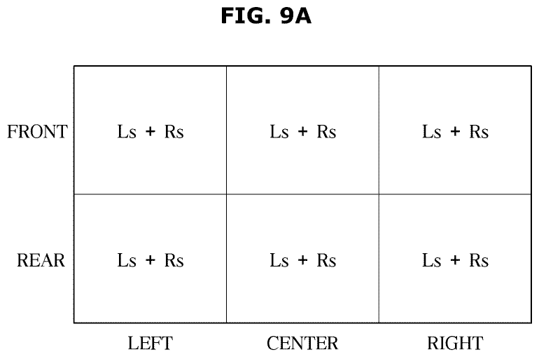

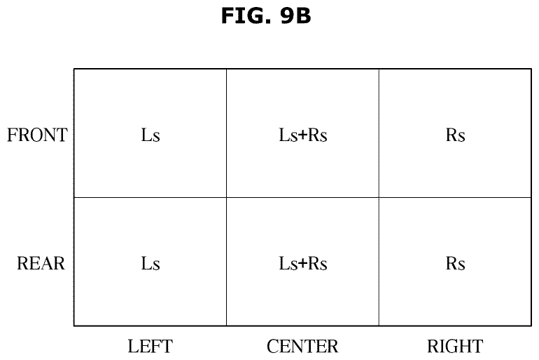

FIG. 9 illustrates a method of processing audio in a case where the number of channels of an audio signal received by the audio device 1 is five, according to an embodiment.

In a case where the number of channels of the audio signal is five, the controller 500 may extract a left surround signal and a right surround signal from the audio signal received by the audio device 1. The five-channel audio signal may be recorded by being distinguished into a left signal L, a right signal R, a center signal C, a left surround signal Ls, and a right surround signal Rs.

The controller 500 may extract the left surround signal Ls and the right surround signal Rs and process the signals according to a defined method. The controller 500 may control sound so that at least one of the left surround signal Ls and the right surround signal Rs is output from the external sub-speaker 10 according to a determined emphasis effect.

In this case as well, sound played from the each external sub-speaker 10 may be processed differently depending on whether there is one or two external sub-speakers 10.

FIG. 9A illustrates an example method of processing sound in a case where there is one external sub-speaker 10, and FIG. 9B illustrates an example method of processing sound in a case where there are two external sub-speakers 10.

Referring to FIG. 9A, in a case where there is one external sub-speaker 10, the controller 500 may control sound to reproduce both the left surround signal Ls and the right surround signal Rs regardless of the position of the external sub-speaker 10.

Referring to FIG. 9B, when the external sub-speaker 10 is located in either the first zone or the fourth zone, the controller 500 may control sound to reproduce the left surround signal Ls, when the external sub-speaker 10 is located in either the third zone or the sixth zone, the controller 500 may control sound to reproduce the right surround signal Rs, and when the external sub-speaker 10 is located in either the second zone or the fifth zone, the controller 500 may control sound to reproduce both the left surround signal Ls and the right surround signal Rs.

In this case, the controller 500 may control sound so that the main speaker 400 reproduces a main signal. In a case where the number of received audio signals is five, the controller 500 may extract the main signal (L+R+C) by combining the left signal L, the right signal R, and the center signal C.

By processing the five-channel audio signal as described above, the aforementioned sound emphasis effect may be realized depending on the number and position of the external sub-speakers 10.

The following describes examples of realizing the aforementioned emphasis effect of sound based on the number and position of the external sub-speakers 10 by processing the five-channel audio signal according to connection scenarios based on the number and position of each external sub-speaker 10.

### <Connection Scenario 1>

Connection scenario 1 is a case where only one external sub-speaker 10 is located at the front. In this case, because the controller 500 determines the front effect as an emphasis effect as described above, the main speaker 400 may reproduce the main signal (L+R+C), and the external sub-speaker 10 may reproduce both the left surround signal Ls and the right surround signal Rs regardless of the position of the external sub-speaker 10, thereby realizing the front effect.

### <Connection Scenario 2>

Connection scenario 2 is a case where two external sub-speakers 10 are located only at the front. In this case, because the controller 500 determines the stereo effect as an emphasis effect as described above, the main speaker 400 may reproduce the main signal (L+R+C), and when the external sub-speaker 10 is positioned on the left, the external sub-speaker 10 may reproduce the left surround signal Ls, when the external sub-speaker 10 is positioned on the right, the external sub-speaker 10 may reproduce the right surround signal Rs, and when the external sub-speaker 10 is positioned in the center, the external sub-speaker 10 may reproduce both the left surround signal Ls and the right surround signal Rs, thereby realizing the stereo effect.

### <Connection Scenario 3>

Connection scenario 3 is a case where one external sub-speaker 10 is located at the front and the other is located at the rear. In this case, because the controller 500 determines the front effect and the surround effect as an emphasis effect as described above, the main speaker 400 may reproduce the main signal (L+R+C), and when the external sub-speaker 10 is positioned on the left, the external sub-speaker 10 may reproduce the left surround signal Ls, when the external sub-speaker 10 is positioned on the right, the external sub-speaker 10 may reproduce the right surround signal Rs, and when the external sub-speaker 10 is positioned in the center, the external sub-speaker 10 may reproduce both the left surround signal Ls and the right surround signal Rs, thereby realizing the front effect and the surround effect.

### <Connection Scenario 4>

Connection scenario 4 is a case where only one external sub-speaker 10 is located at the rear. In this case, because the controller 500 determines the surround effect as an emphasis effect as described above, the main speaker 400 may reproduce the main signal (L+R+C), and the external sub-speaker 10 may reproduce both the left surround signal Ls and the right surround signal Rs regardless of the position of the external sub-speaker 10, thereby realizing the surround effect.

However, in a case where only one external sub-speaker 10 is located at the rear, for example, the external sub-speaker 10 is positioned on the rear left or rear right, when the left surround signal Ls and the right surround signal Rs are reproduced by applying the same amplification rate, the user may feel awkwardness.

In this situation, a sense of space and presence according to the surround effect may not be realized. Therefore, the controller 500 may control the main speaker 400 and/or the external sub-speaker 10 to additionally output by applying a defined weight to the right surround signal Rs or the left surround signal Ls in each situation.

Therefore, the controller 500 may apply a weight of less than 1 to the right surround signal Rs so that the right surround signal Rs is not excessively output from the external sub-speaker 10 located alone at the rear left (fourth zone).

Additionally, the controller 500 may apply a weight of less than 1 to the left surround signal Ls so that the left surround signal Ls is not excessively output from the external sub-speaker 10 located alone at the rear right (sixth zone).

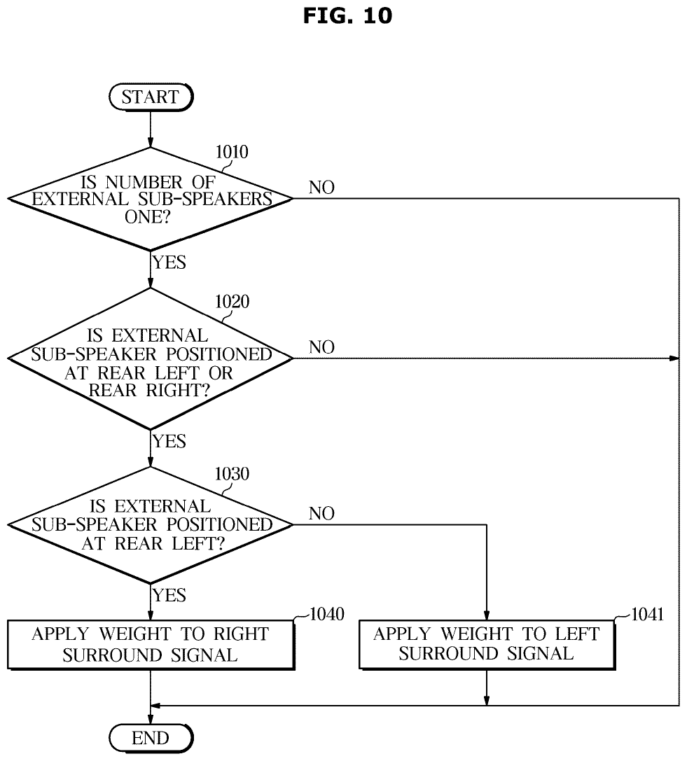

FIG. 10 is a flowchart illustrating a method for controlling the audio device 1 according to an embodiment.

Referring to FIG. 10, the controller 500 may confirm whether the number of external sub-speakers 10 is one (1010), and based on the number of external sub-speakers 10 being one, the controller 500 may confirm whether the one external sub-speaker 10 is positioned at the rear left or rear right (1020).

Additionally, the controller 500 may confirm whether the one external sub-speaker 10 is positioned at the rear left (1030).

Additionally, in a case where the one external sub-speaker 10 is positioned at the rear left, the controller 500 may apply a defined weight to the right surround signal to additionally output from the main speaker 400 and/or the external sub-speaker 10 (1040).

Additionally, in a case where the one external sub-speaker 10 is positioned at the rear right, the controller 500 may apply a defined weight to the left surround signal to additionally output from the main speaker 400 and/or the external sub-speaker 10 (1041).

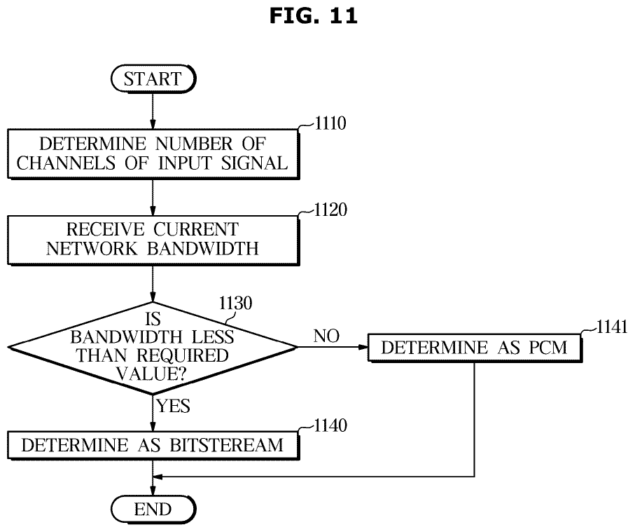

FIG. 11 is a flowchart illustrating a method for controlling the audio device 1 according to an embodiment.

The controller 500 may control the communication circuitry 100 to transmit sound output from the audio device 1 to the external sub-speaker 10. In this case, a sound transmission method may be determined.

The sound transmission method may be determined as either pulse code modulation (PCM) or bitstream. The PCM transmission method occupies a wide network bandwidth. For example, as the number of channels of an audio signal increases, the required value of network bandwidth becomes larger. Therefore, in a case where the available network bandwidth at the time of transmission is small, errors may occur during transmission.

On the other hand, bitstream has a smaller required value of network bandwidth compared to PCM. Therefore, in a case where the PCM transmission method may not be implemented, bitstream may be determined as sound transmission method.

For example, in order to transmit a 6-channel audio signal using PCM, a bandwidth of about 4.2 Mbps may be required, and in order to transmit a 5-7 channel audio signal using bitstream, a bandwidth of about 1.6 Mbps may be required.

Therefore, when transmitting an audio signal with 5 channels or more, in a case where the currently available network bandwidth is lower than the required value of network bandwidth for transmission using PCM, the transmission method using bitstream may be used.

For example, when a 5-channel audio signal is received, as described above, the left surround signal Ls or the right surround signal Rs may be extracted depending on the position of the external sub-speaker 10. However, in a case where the signal is down-mixed to 2 channels and transmitted using PCM transmission, the external sub-speaker 10 may perform a process of restoring the audio signal to the original number of channels, but the signal may not be completely and identically restored.

Therefore, in a case where the bitstream transmission method is adopted in the above situation, an audio signal with 5 channels or more may be transmitted to the external sub-speaker 10 while maintaining the number of channels without down-mixing. Thus, without a restoration process for outputting sound from the external sub-speaker 10, the original signal may be output as it is.

Referring to FIG. 11, the controller 500 of the audio device 1 according to an embodiment may determine the number of channels of an audio signal (1110).

Additionally, the controller 500 may receive a value of current network bandwidth from the communication circuitry 100 (1120).

Additionally, the controller 500 may determine a required value of network bandwidth according to the determined number of channels of the audio signal, and confirm whether the received value of current network bandwidth is less than the required value of network bandwidth (1130).

Based on the current bandwidth being lower than the required value of network bandwidth, the controller 500 may determine the sound transmission method as bitstream (1140).

Based on the current bandwidth being equal to or greater than the required value of network bandwidth, the controller 500 may determine the sound transmission method as PCM (1141).

According to an embodiment, an audio device 1 may include: communication circuitry 100 configured to receive an audio signal from an external source and communicate with at least one external sub-speaker 10; a display 200 configured to display unique identification information of the at least one external sub-speaker 10; an input interface 300 configured to receive a user input indicating a position of the at least one external sub-speaker 10; and a controller 500 configured to control sound output from the at least one external sub-speaker 10 based on a number and the position of the at least one external sub-speaker 10.

The position may include a first zone to a sixth zone obtained by dividing a space around the user into six zones.

The first zone to the sixth zone may include front left, front center, front right, rear left, rear center, or rear right relative to the user.

The controller 500 may be configured to control the sound output from the at least one external sub-speaker 10 such that an emphasis effect applied to the sound output from the at least one external sub-speaker 10 varies depending on the number and the position of the at least one external sub-speaker 10.

The emphasis effect may include at least one of a front effect, a stereo effect, or a surround effect.

The controller 500 may configured to extract a main signal and an ambient signal from the audio signal based on a number of channels of the received audio signal being two, and control the sound output from the at least one external sub-speaker 10 such that the at least one external sub-speaker 10 outputs one of the main signal or the ambient signal according to the emphasis effect.

The controller 500 may be configured to extract a left surround signal and a right surround signal from the audio signal based on a number of channels of the received audio signal being five or more, and control the sound output from the at least one external sub-speaker 10 such that the external sub-speaker 10 outputs at least one of the left surround signal or the right surround signal according to the emphasis effect.

Based on the number of external sub-speakers 10 being one, the controller 500 may be configured to: control the sound output from the at least one external sub-speaker 10 such that a defined weight is applied to the right surround signal in response to the position being rear left, and a defined weight is applied to the left surround signal in response to the position being rear right.

The controller 500 may be configured to determine a required value of network bandwidth for transmitting sound to be output from the audio device 1 to the external sub-speaker 10 based on a number of channels of the audio signal, and determine a transmission method of the sound as either pulse code modulation (PCM) or bitstream based on the required value of network bandwidth and a value of currently available network bandwidth received from the communication circuitry 100.

The controller 500 may be configured to determine the transmission method of the sound as the bitstream based on the number of channels of the received audio signal being five or more and the required value of network bandwidth being greater than the value of currently available network bandwidth.

According to an embodiment, an audio device 1 may further include a main speaker 400 inside the audio device 1.

The controller 500 may be configured to control sound output from the main speaker 400 based on the number and the position of the at least one external sub-speaker 10.

According to an embodiment, a method for controlling an audio device 1 may include: receiving an audio signal from an external source; communicating with at least one external sub-speaker 10; displaying unique identification information of the at least one external sub-speaker 10 on a display 200; receiving a user input indicating a position of the at least one external sub-speaker 10; and controlling sound output from the at least one external sub-speaker 10 based on a number and the position of the at least one external sub-speaker 10.

The receiving on the user input indicating the position may include receiving an input as one of front left, front center, front right, rear left, rear center, or rear right relative to the user.

The controlling of the sound output from the at least one external sub-speaker 10 may include controlling the sound output from the at least one external sub-speaker 10 such that an emphasis effect applied to the sound output from the at least one external sub-speaker 10 varies depending on the number and the position of the at least one external sub-speaker 10.

The controlling of the sound output from the at least one external sub-speaker 10 may include: extracting a main signal and an ambient signal from the audio signal based on a number of channels of the received audio signal being two; and controlling the sound output from the at least one external sub-speaker 10 such that the at least one external sub-speaker outputs one of the main signal or the ambient signal according to the emphasis effect.

The controlling of the sound output from the at least one external sub-speaker 10 may include: extracting a left surround signal and a right surround signal from the audio signal based on a number of channels of the received audio signal being five or more, and controlling the sound output from the at least one external sub-speaker 10 such that the external sub-speaker 10 outputs at least one of the left surround signal or the right surround signal according to the emphasis effect.

The controlling of the sound output from the at least one external sub-speaker 10 may include, based on the number of external sub-speakers 10 being one, applying a defined weight to the right surround signal in response to the position being rear left; applying a defined weight to the left surround signal in response to the position being rear right; and controlling the sound output from the at least one external sub-speaker 10 such that the external sub-speaker 10 outputs the left surround signal and the right surround signal.

The controlling of the sound output from the at least one external sub-speaker 10 may include: determining a required value of network bandwidth for transmitting sound to be output from the audio device 1 to the external sub-speaker 10 based on a number of channels of the audio signal, and determining a transmission method of the sound as either pulse code modulation (PCM) or bitstream based on the required value of network bandwidth and a value of currently available network bandwidth received from the communication circuitry 100.

The determining of the transmission method of the sound may include: determining the transmission method of the sound as the bitstream based on the number of channels of the received audio signal being five or more and the required value of network bandwidth being greater than the value of currently available network bandwidth.

The method may further include controlling the sound output from a main speaker 400 disposed in the audio device 1 based on the number and the position of the at least one external sub-speaker 10.

According to the disclosure, the audio device 1 and method for controlling the same can provide optimal sound to a user by receiving a user input indicating an approximate position of at least one external sub-speaker 10 and processing an audio signal based on the position and number of the external sub-speakers 10.

Additionally, the disclosed audio device 1 and method for controlling the same can provide optimal sound to a user even with a low network bandwidth value by providing a method for determining a sound transmission method according to a value of available network bandwidth.

Furthermore, the disclosed audio device 1 and method for controlling the same can provide optimal sound to a user through a combination of sound output from a plurality of speakers by controlling both sound output from the at least one external sub-speaker 10 and sound output from a main speaker 400.

Meanwhile, the disclosed embodiments may be embodied in the form of a storage medium storing instructions executable by a computer. The instructions may be stored in the form of program code and, when executed by a processor, may generate a program module to perform the operations of the disclosed embodiments.

The machine-readable storage medium may be provided in the form of a non-transitory storage medium. Here, when a storage medium is referred to as “non-transitory,” it can be understood that the storage medium is tangible and does not include a signal (electromagnetic waves), but rather that data is semi-permanently or temporarily stored in the storage medium. For example, a ‘non-temporary storage medium’ may include a buffer in which data is temporarily stored.

According to one embodiment, the methods according to the various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed through an application store (e.g., Play Store™) online. In the case of online distribution, at least a portion of the computer program product may be stored at least semi-permanently or may be temporarily generated in a storage medium, such as a memory of a server 3 of a manufacturer, a server 3 of an application store, or a relay server 3.

Effects obtainable from the disclosure are not limited to the effects mentioned above, and other effects not mentioned will be clearly understood by those skilled in the art to which the disclosure belongs from the description below.

Although embodiments of the disclosure have been described with reference to the accompanying drawings, those skilled in the art will appreciate that these concepts may be embodied in different forms without departing from the scope and spirit of the disclosure, and should not be construed as limited to the embodiments expressly set forth herein.

What is claimed is:

1. An audio device comprising:
communication circuitry configured to receive an audio signal from an external source and communicate with at least one external sub-speaker;
a display configured to display unique identification information of the at least one external sub-speaker;
an input interface configured to receive a user input indicating a position of the at least one external sub-speaker;
memory storing at least one instruction; and
at least one processor,
wherein the at least one instruction, when executed by the at least one processor individually or collectively, causes the audio device to, based on a number of the at least one external sub-speaker and the position of the at least one external sub-speaker, control sound output from the at least one external sub-speaker.

2. The audio device of claim 1, wherein the position comprises a first zone, a second zone, a third zone, a fourth zone, a fifth zone, and a sixth zone obtained by dividing a space around a user into six zones.

3. The audio device of claim 2, wherein the first zone, the second zone, the third zone, the fourth zone, the fifth zone, and the sixth zone respectively comprise a front left, a front center, a front right, a rear left, a rear center, and rear right, relative to the user.

4. The audio device of claim 1, wherein the at least one instruction, when executed by the at least one processor individually or collectively, causes the audio device to, based on the number of the at least one external sub-speaker and the position of the at least one external sub-speaker, control the sound output from the at least one external sub-speaker such that an emphasis effect applied to the sound output from the at least one external sub-speaker varies.

5. The audio device of claim 4, wherein the emphasis effect comprises at least one of a front effect, a stereo effect, or a surround effect.

6. The audio device of claim 5, wherein the at least one instruction, when executed by the at least one processor individually or collectively, causes the audio device to:
based on a number of channels of the audio signal being two, extract a main signal and an ambient signal from the audio signal, and
based on the emphasis effect, control the sound output from the at least one external sub-speaker such that the at least one external sub-speaker outputs one of the main signal or the ambient signal.

7. The audio device of claim 5, wherein the at least one instruction, when executed by the at least one processor individually or collectively, causes the audio device to:
based on a number of channels of the audio signal being five or more, extract a left surround signal and a right surround signal from the audio signal, and
based on the emphasis effect, control the sound output from the at least one external sub-speaker such that the at least one external sub-speaker outputs at least one of the left surround signal or the right surround signal.

8. The audio device of claim 7, wherein, the number of the at least one external sub-speaker is one, and
wherein the at least one instruction, when executed by the at least one processor individually or collectively, causes the audio device to control the sound output from the at least one external sub-speaker such that:
a defined weight is applied to the right surround signal based on the position being rear left, and
a defined weight is applied to the left surround signal based on the position being rear right.

9. The audio device of claim 1, wherein the at least one instruction, when executed by the at least one processor individually or collectively, causes the audio device to:
based on a number of channels of the audio signal, determine a required value of network bandwidth for transmitting sound to be output from the audio device to the at least one external sub-speaker, and
based on the required value of network bandwidth and a value of currently available network bandwidth received from the communication circuitry, determine a transmission method of the sound as either pulse code modulation (PCM) or bitstream.

10. The audio device of claim 9, wherein the at least one instruction, when executed by the at least one processor individually or collectively, causes the audio device to, based on the required value of network bandwidth being greater than the value of currently available network bandwidth, determine the transmission method of the sound as the bitstream.

11. The audio device of claim 1, further comprising:
a main speaker provided inside the audio device,
wherein the at least one instruction, when executed by the at least one processor individually or collectively, causes the audio device to, based on the number and the position of the at least one external sub-speaker, control sound output from the main speaker.

12. A method for controlling an audio device, the method comprising:
receiving an audio signal from an external source;
communicating with at least one external sub-speaker;
displaying unique identification information of the at least one external sub-speaker on a display;
receiving a user input indicating a position of the at least one external sub-speaker; and
controlling sound output from the at least one external sub-speaker based on a number of the at least one external sub-speaker and the position of the at least one external sub-speaker.

13. The method of claim 12, wherein the receiving the user input indicating the position comprises receiving an input indicating one of a front left, a front center, a front right, a rear left, a rear center, or a rear right, relative to a user.

14. The method of claim 12, wherein the controlling the sound output from the at least one external sub-speaker comprises, based on the number of the at least one external sub-speaker and the position of the at least one external sub-speaker, controlling the sound output from the at least one external sub-speaker such that an emphasis effect applied to the sound output from the at least one external sub-speaker varies.

15. The method of claim 14, wherein the controlling the sound output from the at least one external sub-speaker comprises:
extracting a main signal and an ambient signal from the audio signal based on a number of channels of the audio signal being two; and
controlling the sound output from the at least one external sub-speaker such that the at least one external sub-speaker outputs one of the main signal or the ambient signal according to the emphasis effect.
